(19) United States
(12) Patent Application Publication
(10) Pub. No.: US 2009/0285528 A1
(43) Pub. Date: Nov. 19, 2009

(54) CLADDING GRATING AND FIBER SIDE-COUPLING APPARATUS USING THE SAME

(75) Inventors: CHUN LIN CHANG, TAIPEI COUNTY (TW); SHENG LUNG HUANG, KAOHSIUNG CITY (TW); SHIH TING LIN, TAINAN CITY (TW); HONG XI CAO, KAOHSIUNG COUNTY (TW); CHIEH HU, CHIAYI CITY (TW)

Correspondence Address: WPAT, PC;INTELLECTUAL PROPERTY ATTORNEYS, 2030 MAIN STREET, SUITE 1300, IRVINE, CA, 92614, US

(73) Assignee: INDUSTRIAL TECHNOLOGY RESEARCH INSTITUTE, HSINCHU (TW)

(21) Appl. No.: 12/266,920

(22) Filed: Nov. 7, 2008

(30) Foreign Application Priority Data
May 14, 2008 (TW) 097117648

(51) Int. Cl. G02B 6/34

(52) U.S. Cl. 385/37

(57) ABSTRACT

A fiber side-coupling apparatus can be spliced with active fiber as a fiber-based side-coupler in series at both sides for distributively-pumped monolithic fiber lasers. This side-coupling apparatus includes a large-mode-area double-clad passive optical fiber. A cladding grating, formed on the cladding surface of the passive fiber, comprises a plurality of grating members and a reflection layer formed thereon. A laser diode bar array is disposed on one side of the optical fiber opposite the cladding grating. A collimation device, placed between the optical fiber and the laser diode bar array, is used to collect the pump beam to the cladding grating as much as possible in fast axis and collimate the pump beam to be incident to the cladding grating in slow axis as normally as possible. The collimated pump beams emitted from a laser diode bar array are normally incident to the cladding grating within the alignment tolerance of ±2 to ±4 degrees. Without the reentrance loss effect, the pump beams diffracted and reflected by the cladding grating propagates in the inner cladding of the passive fiber due to total internal reflection. In one embodiment, the grating member can be a binary or blazed cross section.

### BACKGROUND OF THE INVENTION

1. Field of the Invention

The present invention relates to a fiber side-coupling apparatus with a cladding grating thereof.

2. Description of the Related Art

Due to recent rapid development of large-mode-area double-clad ytterbium-doped fiber technology, the huge, high-energy-consumption, high power laser and its amplifier traditionally used, such as solid-state laser, excimer laser, or carbon dioxide gas laser, can now be replaced by a high power fiber laser and amplifier having higher conversion efficiency, lower requirements of heat dissipation and improved beam quality. New designs of fiber-based and low-cost key components for all-fiber-based or so-called monolithic high power fiber laser and amplifier systems show great potential for new industrial applications.

High power pump sources are necessary for high power, high intensity fiber lasers and amplifiers. Different kinds of coupling methods for pump beams exhibit different levels of performance with regards to wall-plug efficiency, beam quality, and power stability. The methods for injecting propagating pump beam are of two types: end coupling and side coupling. The side-coupling method to achieve a distributively-pumped scheme is generally better, because the end-coupling method exhibits inferior beam quality due to configuration limitations and problems of heat dissipation. Moreover, by utilizing a laser diode bar array, which can only be applied using high power operation with semiconductor laser, as pump source without pigtailed fiber, the requirement of coupling a pump beam into a passive optical fiber between pump sources and side-coupling apparatuses can be simplified, thereby reducing the overall manufacturing cost by about 30% without using pigtailed pump fiber.

U.S. Pat. No. 5,854,865 discloses a technique relying on the fabrication of a V-groove or a micro-prism on the cladding surface of an optical fiber. Single-emitter laser diodes or other suitable means in the proximity of an optical fiber emit light as pump source. Pump beams traveling transversely, illuminating on the side facet of the V-groove, are reflected due to total internal reflection, and then propagate in the inner cladding of the optical fiber along the longitudinal direction of the optical fiber. However, the cutting of the V-grooves generally weakens the fiber structure, decreasing robustness and production yield. In addition, semiconductor laser as pump source can only be a single emitter for V-groove, so the maximum output power is not easily promoted.

U.S. Pat. No. 6,801,550 discloses a modified V-groove structure on the cladding surface of an optical fiber permitting multiple broad-area emitters for side-coupling scheme. The modified V-groove structure can raise the maximum value of the cumulative pump power by fine tuning the facet angle of the V-groove, but the manufacture cost is higher due to greater complexity and necessary higher precision of manufacture resulting in lower production yield. Greater care must be taken to align and maintain all pump beams, which must be injected within a certain range of incident angle from multiple broad-area emitters to the V-groove structure, respectively. Furthermore, such a modified V-groove approach is still only compatible with a semiconductor laser having a single-emitter array, not a bar array. The potential application of high power fiber laser is still not qualified effectively. The side-coupling method using the reflection grating to transversely deliver the pump beam into a large-mode-area double-clad fiber by diffraction is proposed by R. Herda, A. Liem, B. Schnabel, “Efficient side-pumping of fibre lasers using binary gold diffraction gratings”, Electronics Letters, 39 (3), pp. 276-277 (2003). In this technique the binary reflection grating is adhered to the cladding surface of the optical fiber without any modification to the fiber itself. There is an index matching substance disposed therebetween for reducing the coupling loss. However, the index matching substance cannot allow the passage of a high power pump beam because of suffering from thermal degradation; therefore the maximum output laser power in the side-pumped scheme is limited to below the kilowatt level. Further, this configuration is suitable only for a single-emitter laser diode, and is therefore not applicable to high power applications or for the consideration of the reentrance loss effect while using laser diode bar array.

U.S. Pat. No. 6,842,570 discloses an optical system including a tapered light guide (TLG) optically coupled into a signal fiber. The TLG includes a diffraction grating aperture with an array of diode emitters positioned adjacent thereto. The pump beam is diffracted into the TLG and propagates into the signal fiber. However, this patent discloses no method of avoiding the reentrance loss while using laser diode bar array. Furthermore, laying an array of diode emitters directly against the diffraction grating aperture should significantly decrease the diffraction efficiency because the divergent angle of a laser diode bar array in slow axis are large (typically about 10 degrees) to conform the incident angle within the effective range.

### SUMMARY OF THE INVENTION

The present invention proposes a fiber-based side-coupling apparatus of fiber laser, which comprises a semiconductor laser diode bar array and a cladding grating. The semiconductor laser diode bar array, disposed at one side of an optical fiber, is configured for producing pump beams and a cladding grating, which comprises a plurality of grating members and a reflection layer. The grating members are periodically formed on a cladding surface at the other side of the optical fiber, opposite a laser diode bar array, of an inner cladding and arrayed along a longitudinal direction of the optical fiber, wherein the grating members diffract the pump beams to produce diffracted beams propagating in the inner cladding of the optical fiber. The reflection layer, disposed on the grating members, is configured to reflect the diffracted pump beams into the optical fiber.

The present invention proposes a cladding grating for directing pump beams from a laser diode bar array, disposed at one side of an optical fiber, into the inner cladding of the optical fiber, wherein the cladding grating comprises a plurality of grating members and a reflection layer. The grating members, periodically formed on a cladding surface at the other side of the optical fiber opposite the laser diode bar array, are arrayed along a longitudinal direction of the optical fiber. The collimated pump beams diffracted by the grating members are reflected by the reflection layer to propagate in the inner cladding of the optical fiber.

The present invention proposes a cladding grating for coupling pump beams from a laser diode bar array, disposed at one side of an optical fiber, into the optical fiber, and the grating comprises a plurality of grooves and a reflector. The grooves, periodically formed on a cladding surface at the side of the optical fiber opposite the pump source, are arrayed along a longitudinal direction of the optical fiber. The reflector includes a reflective diffraction structure corresponding to the grooves, wherein the reflector embedded in the grooves diffracts and reflects the pump beams to propagate in the inner cladding of a passive fiber due to total internal reflection.

### BRIEF DESCRIPTION OF THE DRAWINGS

The invention will be described according to the appended drawings in which:

FIG. 1 shows a fiber side-coupling apparatus for a side-pumped fiber laser system according to one embodiment of the present invention;

FIG. 2 shows a cross-section view of a cladding grating with a binary cross section according to one embodiment of the present invention;

FIG. 3 shows a cross-section view of a cladding grating with a blazed cross section according to one embodiment of the present invention;

FIG. 4 is a graph showing the optimal ±1-order diffraction efficiencies of the binary and the blazed grating structures for various grating pitches according to one embodiment of the present invention;

FIG. 5 is a graph showing the optimal ±1-order diffraction efficiency of binary grating structures for various grating depths and duty cycles at 640-nm grating pitch for 915-nm pump wavelength according to one embodiment of the present invention;

FIG. 6 is a graph showing the optimal ±1-order diffraction efficiency of the blazed grating structures for various grating depths and duty cycles at 640-nm grating pitch for 915-nm pump wavelength according to one embodiment of the present invention;

FIGS. 7 and 8 show a collimation mechanism of pump beam for cladding grating with two kinds of cross section according to the first embodiment of the present invention;

FIGS. 9 and 10 show a collimation mechanism of pump beam to utilize a pair of cylindrical lenses in fast and slow axis, respectively, according to the second embodiment of the present invention;

FIGS. 11 and 12 show a collimation mechanism of pump beam to utilize a micro-lens array in fast and slow axis, respectively, according to the third embodiment of the present invention;

FIG. 13 is a diagram showing, with suitable diffraction angle for pump beams to propagate in the inner cladding of the passive fiber by the total internal reflection as shown in the inset, the range of grating length vs. inner cladding of a passive fiber within a range of grating pitch for avoiding the reentrance loss effect according to the embodiment of the present invention;

FIG. 14 is a diagram showing the ±1-order diffraction angles for various incident angles in a 640±5-nm grating pitch, with the inset showing the reflectance at the boundary between inner and outer cladding for various incident angles with the grating pitch of 640 nm according to the embodiment of the present invention; and

FIG. 15-16 are diagrams showing the optimal ±1-order diffraction efficiency of binary and blazed gratings, respectively, for various incident angles in different grating pitches according to the embodiment of the present invention.

### DETAILED DESCRIPTION OF THE INVENTION

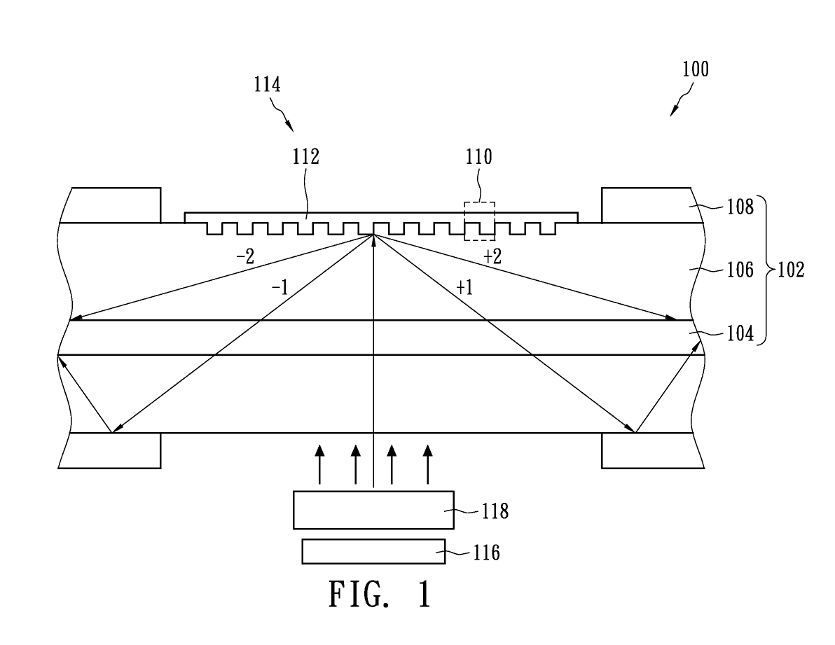

FIG. 1 shows a fiber side-coupling apparatus 100 for a side-pumped fiber laser system according to one embodiment of the present invention. The side-coupling apparatus 100 of the present invention comprises a passive optical fiber 102, a cladding grating 114, a beam collimating system 118 and a semiconductor laser diode bar array 116. The passive optical fiber 102 comprises a fiber core 104, an inner cladding 106 surrounding the fiber core 104 and an outer cladding 108 surrounding the inner cladding 106. The gratings 114 acting as the reflection-type diffraction grating comprise a plurality of grating members 110 periodically formed on the cladding surface of the inner cladding 106 and arrayed along the longitudinal direction of an optical fiber 102 and a reflection layer 112 coated on the grating members 110. The grating members 110 are periodically formed on the cladding surface at the side opposite the laser diode bar array 116, and the arrangement thereof comprises at least one grating pitch. The pump beam emitted from the laser diode bar array 116 into the inner cladding of the passive fiber 102 is diffracted and reflected by the cladding grating 114 and changes its direction, and then propagates in the inner cladding 106 due to total internal reflection.

The passive optical fiber 102 used in the fiber side-coupling apparatus 100 of the present invention comprises different types of large-mode fibers such as a single-core fiber, a twin-core fiber, a single-clad fiber, a double-clad fiber, etc. The fiber core 104 may comprise the common dopants such as ytterbium, erbium and other similar gain media. The dopants can be pumped to produce gain for signal light having a predetermined wavelength propagating in the fiber core 104. In a preferred embodiment, the fiber core 104 is doped with ytterbium, and the ytterbium-doped fiber laser and amplifier can be pumped within the gain absorption spectrum of ytterbium in the material of the passive fiber.

The laser diode bar array 116 comprises a semiconductor laser diode bar array, which emits pump beam having a predetermined central wavelength and bandwidth. The gain medium in the fiber core 104 absorbs the pump beam emitted from the laser diode bar array 116 and can produce gain for optical amplifier or activate the laser.

In one embodiment, the cross sections of the grooves, formed by the grating members 110 arranged periodically and used for diffracting pump beams, can comprise different kinds of shapes. The reflection layer 112 can be made of any material with reflective characteristics for the preferred central wavelength such as metals of high reflectivity, which may be gold, aluminum, silver, copper, or the like, or dielectric material.

The pump beam can propagate in the inner cladding 106 due to total internal reflection because the pump beam traveling in one medium with higher refractive index is reflected at the interface between the medium with higher refractive index and the other with lower refractive index. The critical angle is the minimum angle of incidence at which total internal reflection can occur.

The cladding grating 114 separates and reflects an incident pump beam into several diffracted pump beams with different orders traveling in different directions. Each order of pump beam has a different diffraction angle, and therefore there are different angles incident to the interface between the inner cladding 106 and the outer cladding 108. To achieve the optimal diffraction efficiency, all diffracted pump beam shall be optimized to the ±1-order only as much as possible. If the incident angle of the ±1-order pump beam is greater than the critical angle, the ±1-order pump beam can propagate in the inner cladding 106. The grating pitch of the optimal ±1-order diffraction efficiency can be determined by the following equation:

$$Λ \leq \frac{λ}{\sqrt{{n}_{clad}^{2} - N {A}_{clad}^{2}}}$$

where Λ is the grating pitch, λ is the central wavelength of the pump source, n_{clad} is the refraction index of an inner cladding 106 and NA_{clad} is the numerical aperture of an inner cladding 106 relating to the outer cladding 108. According to the above equation, the longest grating pitch, having the strongest ±1-order diffracted beams, that conforms to the total reflection simultaneously for coupling light into the inner cladding of a passive fiber depends on the grating pitch, Λ, the refraction index of an inner cladding 106, n_{clad}, and the numerical aperture of an inner cladding 106 relating to the outer cladding 108, NA_{clad}

For example, consider the case where NA_{clad}=0.46, n_{clad}=1.4507 and λ=915 nm. In this instance, for the incident angle of the ±1-order diffracted beams at the interface greater than the critical angle of 80°, the upper limit of grating pitch is:

Λ=665 nm

In the foregoing example, the grating pitch can be easily fabricated using the current semiconductor manufacturing technology.

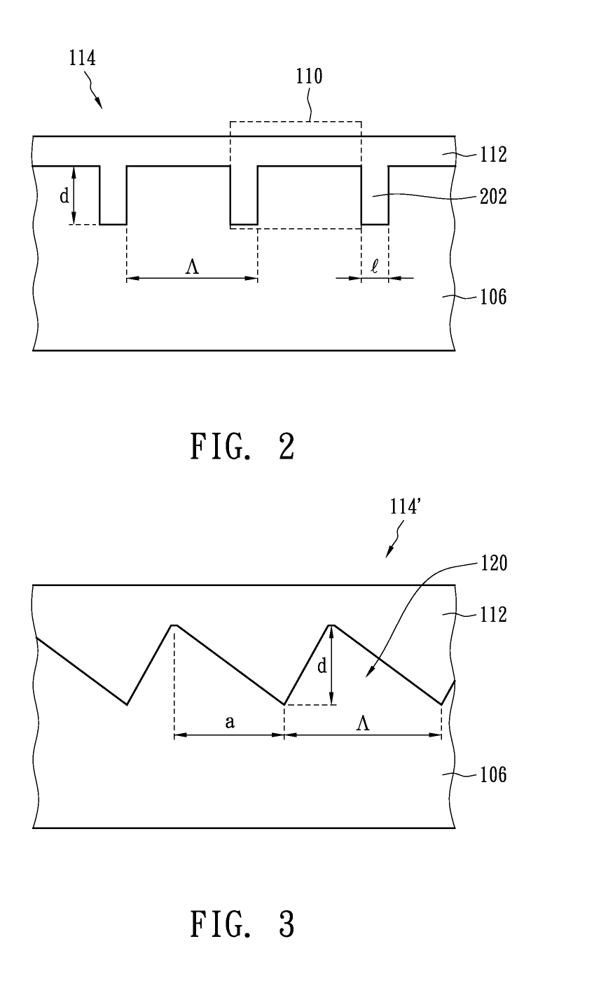

FIG. 2 shows a cross section view of a cladding grating 114 with a binary cross section according to one embodiment of the present invention. In the present embodiment, the cladding grating 114 comprises a plurality of grating members 110 and each grating member 110 has a binary cross section. The grating members 110 are periodically spaced along the longitudinal direction of the passive optical fiber 102 by grating pitch Λ. The grating member 110 is the fundamental unit of the cladding grating 114, and is not limited to what is shown in FIG. 2. The method of fabricating the cladding grating 114 initially etches grooves on the cladding surface of the inner cladding 106, and each groove has line width 1 and depth d. Thereafter, a reflection layer 112 is disposed on the grooves. The reflection layer 112 can be a reflector with a reflective diffraction structure 202 by completely filling the grooves with the material of the reflection layer 112. The technology for fabricating the cladding grating 114 comprises electron beam and optical lithography technique.

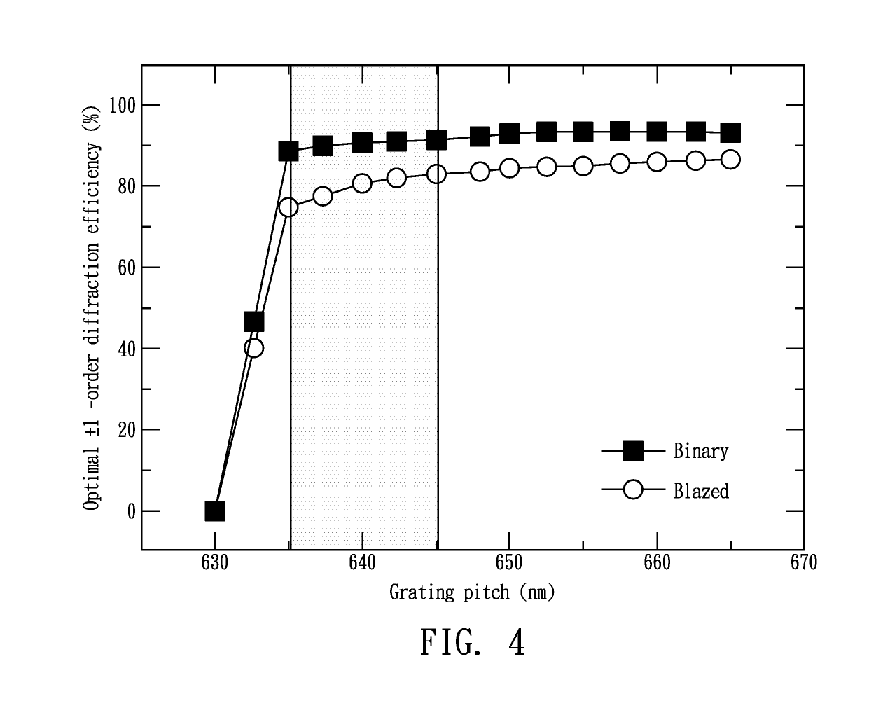

FIG. 3 shows a cross section view of a cladding grating 114′ with a blazed cross section according to another embodiment of the present invention. In this embodiment, the cladding grating 114′ comprises a plurality of grating members 110, each of which has an asymmetrical blazed cross section. The grating members 120 are periodically spaced along the longitudinal direction of the passive optical fiber 102. Each grating member 120 has a tip displacement a and depth d.

Although the cladding grating with two kinds of cross sections are proposed in the above-described embodiments, the present invention is not limited to the examples below. The present invention is also applicable for the use with a convex or concave grating with other kinds of shape in cross section.

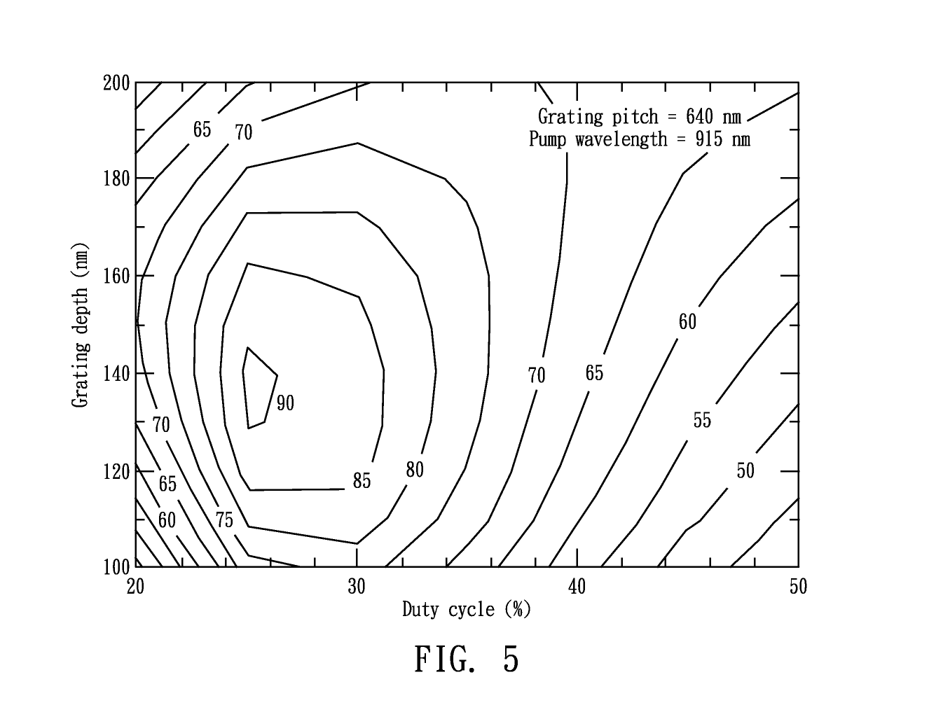

FIG. 4 is a graph showing the optimal ±1-order diffraction efficiencies of the binary and the blazed grating structures for various grating pitches at a 915-nm pump wavelength according to another embodiment of the present invention. Numerical simulations are performed on the above-described grating structures, and the results can determine the optimal designs. “DiffractMOD,” used to perform simulation, is a two-dimensional simulation tool developed by Rsoft Design Group Inc. The cladding grating 114 having the grooves of the binary shape in cross section slightly outperforms the cladding grating 114′ having the grooves of the blazed shape in cross section as shown in FIG. 4. This result suggests that the grating cross-section shape has an effect on the ±1-order diffraction efficiency. If the grating pitch is over 640 nm, the diffraction efficiencies of both gratings 114 and 114′ can exceed 80%; if the grating pitch is 665 nm, both gratings 114 and 114′ achieve the maximum diffraction efficiencies. The diffraction efficiency is defined as the ratio of the incident pump power to the diffracted pump power propagating in the optical fiber.

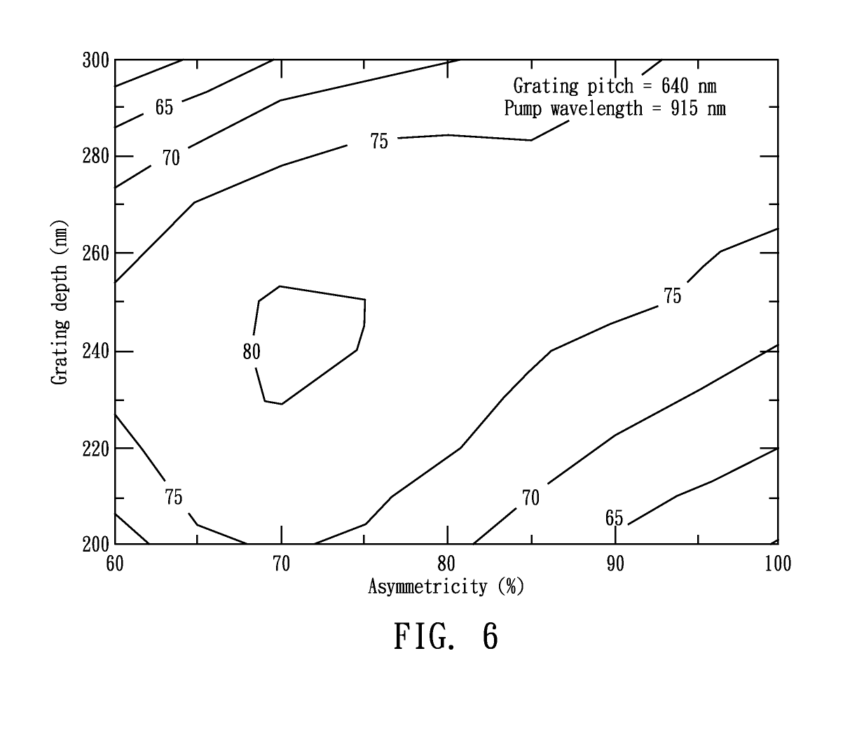

FIG. 5 is a graph showing the optimal ±1-order diffraction efficiency of the binary grating structures for various grating depths and duty cycles at 640-nm grating pitch for 915-nm pump wavelength according to one embodiment of the present invention. Referring primarily to FIG. 5 but also referring to FIG. 2, FIG. 5 shows a graph for the optimal grating depth and duty cycle analysis of a cladding grating 114 having a binary cross section where the grating pitch is 640 nm and the pump wavelength is 915 nm. To keep the diffraction efficiency above 85%, the duty cycle (1/Λ) should be in the range of 28±4% and the grating depth should be in the range of 140±22 nm as shown in FIG. 5.

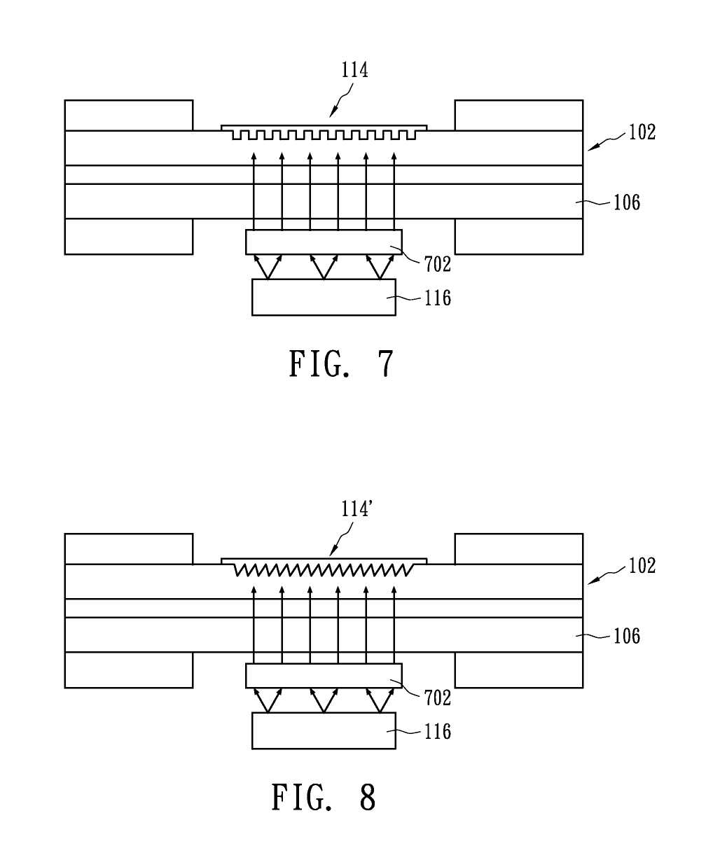

FIG. 6 is a graph showing the optimal ±1-order diffraction efficiency of the blazed grating structures for various grating depths and asymmetricity at 640-nm grating pitch for 915-nm pump wavelength according to another embodiment of the present invention. Referring primarily to FIG. 6 but also referring to FIG. 3, FIG. 6 shows a graph for the optimal grating depth and asymmetricity analysis of a cladding grating 114′ having a blazed cross section where the grating pitch is equal to 640 nm and the pump wavelength is 915 nm. To keep the diffraction efficiency above 80%, the asymmetricity (a/Λ) should be in the range of 72±4% and the grating depth should be in the range of 242±12 nm.

The bandwidth exhibited by a high power semiconductor laser diode bar array is about 2-3 nm. It is necessary to simulate the effect of a laser wavelength on the ±1-order diffraction efficiency of the above grating structures using different pump wavelength conditions. The analysis result in accordance with one embodiment of the present invention shows that the ±1-order optimal diffraction efficiency of a cladding grating 114 having a binary cross section, which has a grating pitch of 640 nm, a grating depth of 137 nm and a duty cycle of 25%, remains above 90% for the wavelength range of 915±5 nm; the ±1-order optimal diffraction efficiency of a cladding grating 114′ having a blazed cross section, which has a grating pitch of 640 nm, a grating depth of 240 nm and an asymmetricity of 72%, remains above 72% for the pump wavelength range of 915±5 nm. Therefore, a high power pump source having 2-3 nm bandwidth has no effect on the grating structures presented by the present invention.

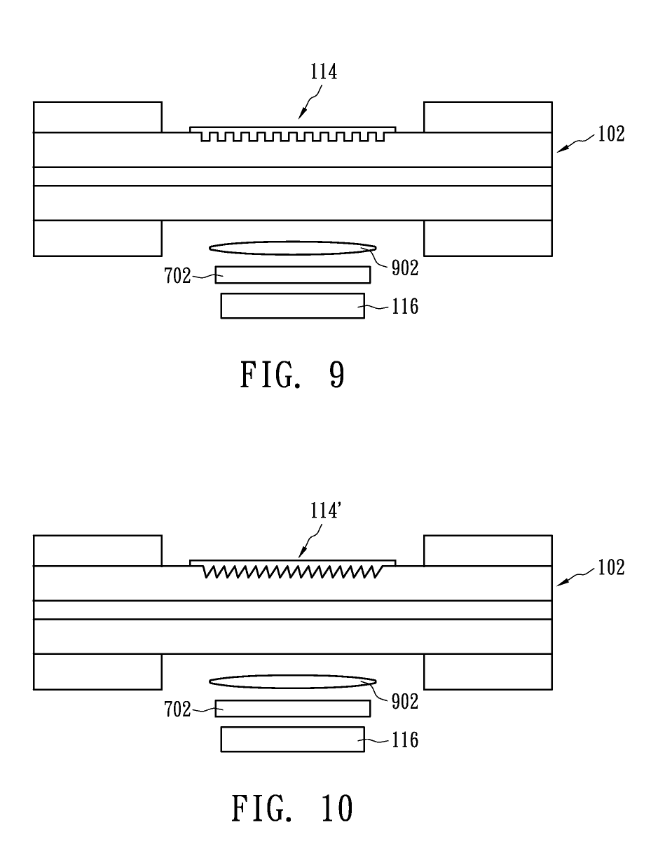

FIGS. 7 and 8 show a collimation mechanism of pump beam according to the first embodiment of the present invention. The divergence of pump beams emitted from a laser diode bar array 116 is large and typically 10 degrees in slow axis and 40 degrees in fast axis, respectively. The fast-axis divergence limits the light collection efficiency from the laser diode bar array 116 to the cladding grating 114, 114′, and the slow-axis divergence shall be confined for optimizing the ±1-order diffraction efficiency and satisfying total internal reflection also. To handle the above problems, a collimation device 702 should be disposed between the laser diode bar array 116 and the passive optical fiber 102. The collimation device 702 focuses the pump beams in fast axis to the cladding grating 114, 114′ to increase the side-coupling efficiency, which represents the ratio of the pump power before entering into an optical fiber to that propagating in the inner cladding of a passive fiber 106. At the same time, the collimation device 702 also collimates the pump beams emitted from each bar in the laser diode bar array in slow axis to the cladding grating 114 and 114′ in their effective range, respectively.

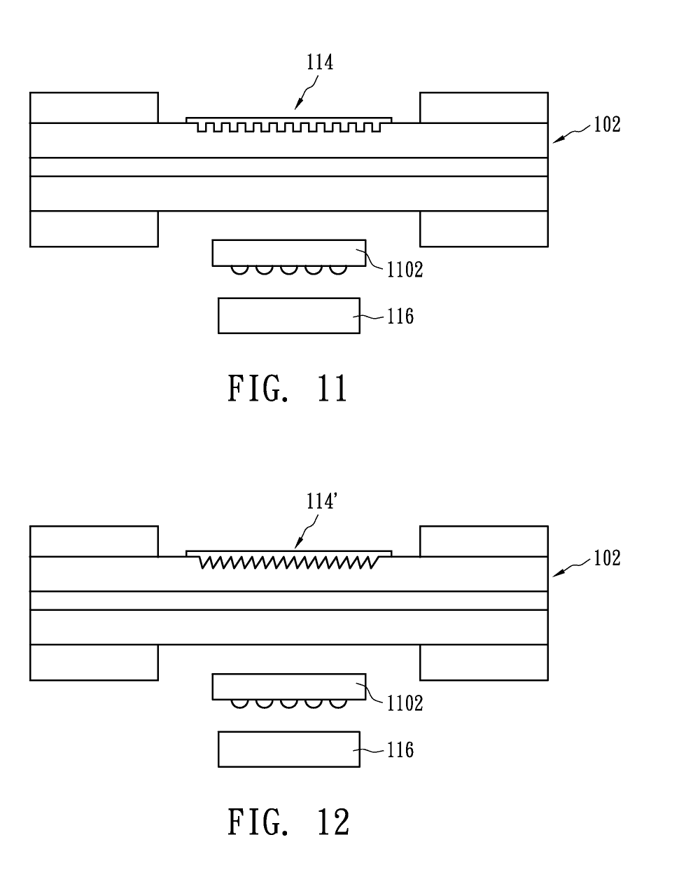

FIGS. 9 and 10 show a collimation mechanism of pump beam to utilize a pair of cylindrical lenses in fast and slow axis, respectively, according to the second embodiment of the present invention. To increase the overall side-coupling efficiency, a fast-axis collimation device 703 and then a slow-axis collimation device 902 are disposed. The pump beams are focused and collimated in fast and slow axis, respectively, by a pair of cylindrical lenses 703 and 902.

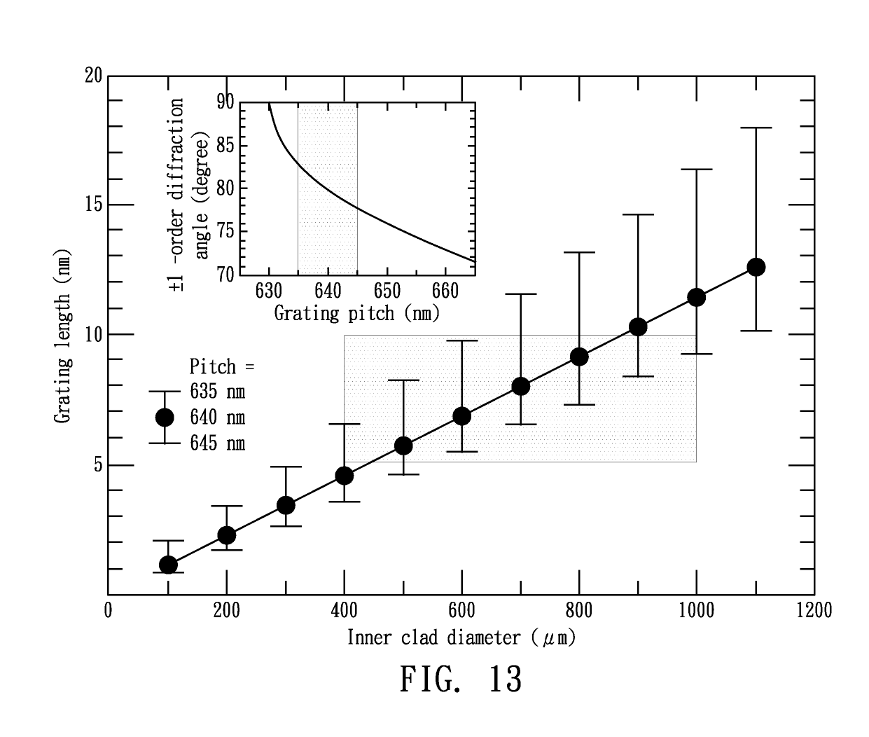

FIGS. 11 and 12 show a collimation mechanism of pump beam to utilize a micro-lens array in fast and slow axis, respectively, according to the third embodiment of the present invention. A micro-lens array 1102 is another customized solution that can be used for compact integration compared to the second embodiment of the present invention mentioned above.

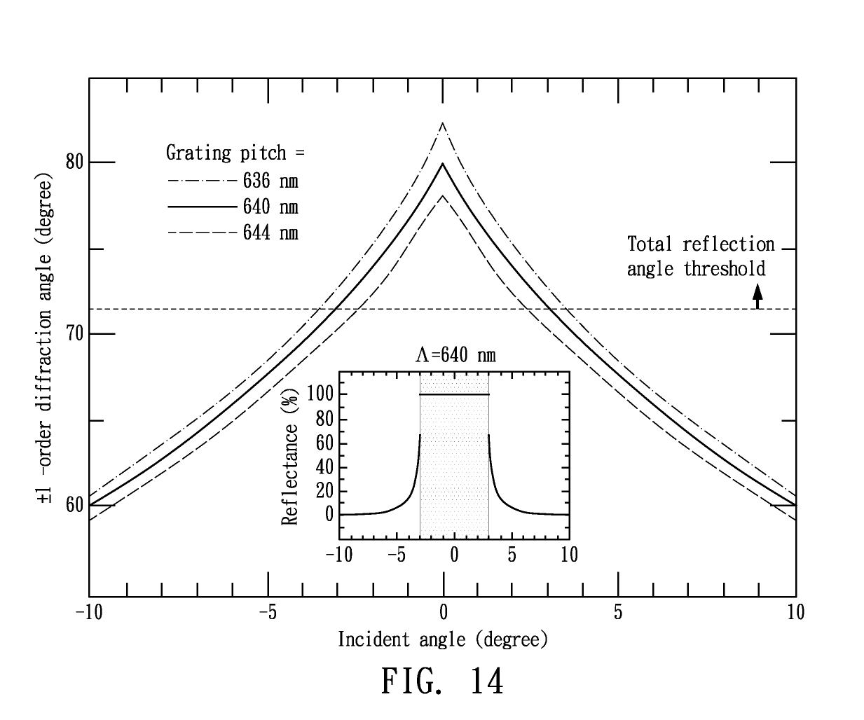

Referring to FIG. 13, to satisfy the total internal reflection and the grating diffraction law without the reentrance loss effect as shown in FIG. 4 and FIG. 13, the viable range of grating pitches are 640±5 nm. The 640 nm pitch is selected to allow a fabrication error of ±5 nm. The inner-clad diameters should be from 400 to 800 μm for the sufficient grating length to fit the width of a laser diode bar array. Furthermore, in this example the simulation result also shows that the incident angles on the refractive interface of the ±1-order diffracted beams are about 78-83 degrees, which is greater than the critical angle of 72 degrees for total internal reflection if the grating pitch is about 640±5 nm.

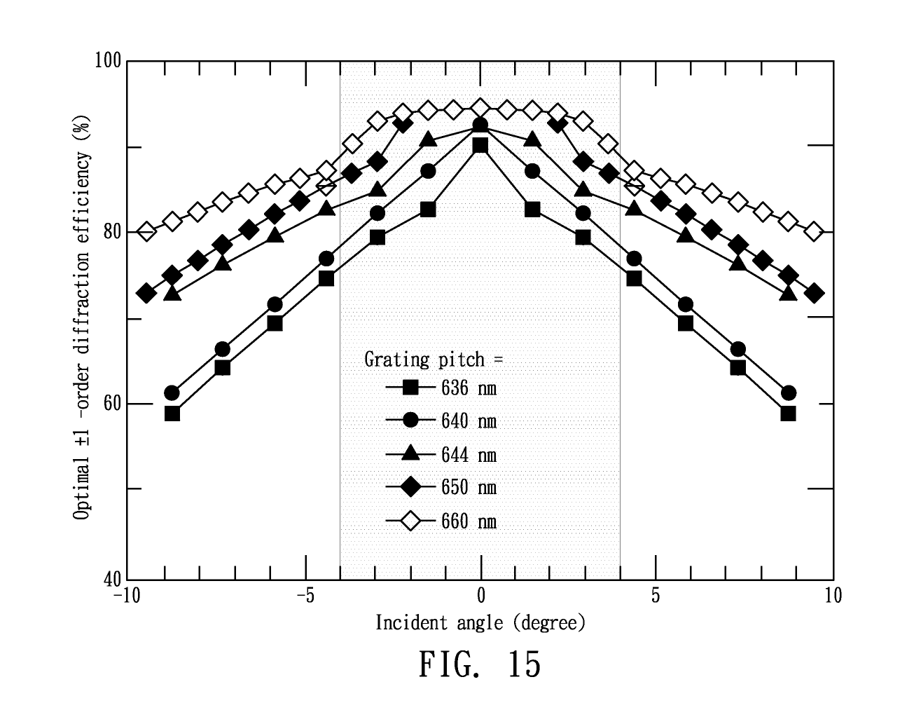

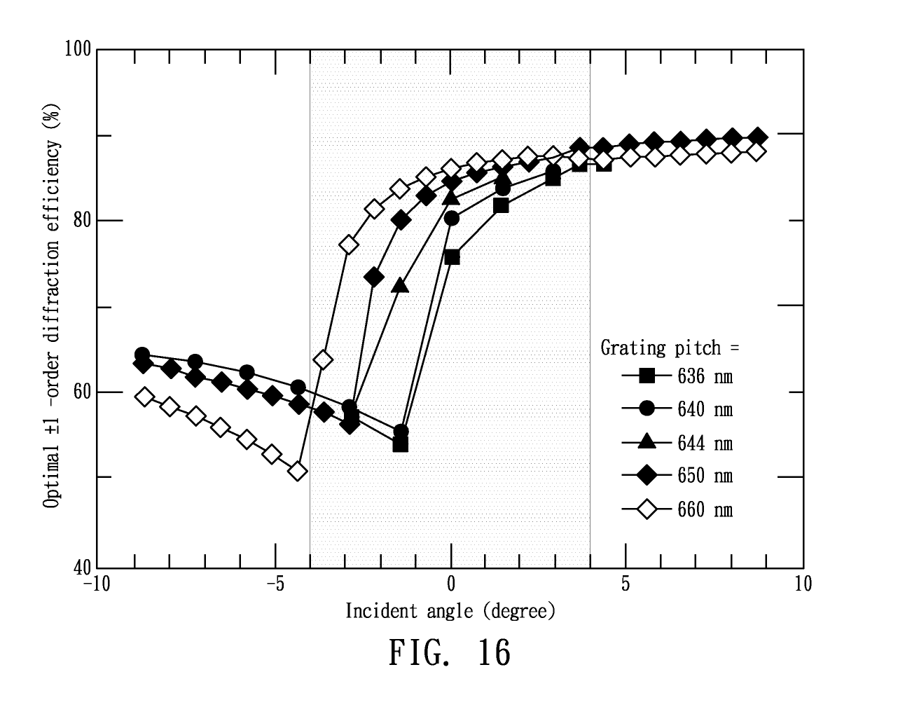

Referring to FIG. 14-16, an unexpectedly narrow range, i.e. ±2° to ±4°, of incident angle tolerance is observed from air to gold grating via pure silica. This means that the beam collimation of pump source is necessary because the divergence angle of a laser diode bar array is typically about 10°. The longer pitch also enables the better uniformity of the optimal ±1-order diffraction efficiency with larger tilt angle for the binary gratings. The blazed gratings are sensitive to tilt angle in one direction only. The analysis of the angular variation effect for the incident pump beam shows that the angle of pump beam incident to the cladding grating 114 can vary ±2˜±4 degrees without having any influence on the ±1-order diffracted beams propagating in an optical fiber due to total internal reflection, and the analysis result is better than the prior art proposed by R. Herda et al.

The above-described embodiments of the present invention are intended to be illustrative only. Numerous alternative embodiments may be devised by persons skilled in the art without departing from the scope of the following claims.

What is claimed is:

1. A cladding grating for directing pump beams from a laser diode bar array, disposed at one side of an optical fiber, into the inner cladding of the optical fiber, the cladding grating comprising:
a plurality of grating members, periodically formed on a cladding surface at the other side of the optical fiber, opposite the laser diode bar array, of an inner cladding, arrayed along a longitudinal direction of the optical fiber, wherein the grating members diffract the pump beams to produce diffracted beams propagating in the inner cladding of the optical fiber; and
a reflection layer, disposed on the grating members, configured to reflect the diffracted pump beams into the optical fiber.

2. The cladding grating of claim 1, wherein the diffracted pump beams propagate in the inner cladding of the optical fiber due to total internal reflection.

3. The cladding grating of claim 1, wherein the grating members are closely spaced by a predetermined grating pitch which satisfies the following equation:
$$Λ \leq \frac{λ}{\sqrt{{n}_{clad}^{2} - N {A}_{clad}^{2}}}$$
where Λ is the grating pitch, λ is the central wavelength of the pump source, n_{clad} is the refraction index of inner cladding, and NA_{clad} is the numerical aperture of inner to outer cladding, respectively.

4. The cladding grating of claim 1, wherein each grating member has a binary cross section.

5. The cladding grating of claim 4, wherein the grating members have a grating pitch of 660-700 nm, a grating depth of 120-170 nm and a duty cycle of 20%-45%.

6. The cladding grating of claim 5, wherein the grating members have the grating pitch of 640±5 nm, the grating depth of 140±40 nm and the duty cycle of 28±8% for the diffraction efficiency of at least 75% in the case of 915±5 nm within ±4-degree incident angles.

7. The cladding grating of claim 4, wherein the grating members have a grating pitch of 640±5 nm.

8. The cladding grating of claim 1, wherein each grating member has a blazed cross section.

9. The cladding grating of claim 8, wherein the grating members have the grating pitch of 660-700 nm, a grating depth of 200-400 nm and a asymmetricity of 60%-100%.

10. The cladding grating of claim 9, wherein the grating members have the grating pitch of 640±5 nm, the grating depth of 240±10 nm and the asymmetricity of 68±3% for the diffraction efficiency of at least 80% in the case of 915±5 nm within the incident angle of 0-4 degrees.

11. The cladding grating of claim 8, wherein the grating members have a grating pitch of 640±5 nm.

12. The cladding grating of claim 1, wherein the reflection layer is made of a metal or dielectric material.

13. A cladding grating for coupling pump beams from a laser diode bar array, disposed at one side of an optical fiber, into the optical fiber, the grating comprising:
a plurality of grooves, periodically formed on a cladding surface at the other side of the optical fiber, opposite the laser diode bar array, of an inner cladding, arrayed along a longitudinal direction of the optical fiber; and
a reflector including a reflective diffraction structure corresponding to the grooves;
wherein the reflector embedded in the grooves diffracts the pump beams to produce diffracted beams propagating through the optical fiber by total internal reflection.

14. The cladding grating of claim 13, wherein each groove has a binary cross section, and the grooves have a grating pitch of 660-700 nm, a grating depth of 120-170 nm and a duty cycle of 20%-45%.

15. The cladding grating of claim 14, wherein the grooves have the grating pitch of 640±5 nm, the grating depth of 140±40 nm and the duty cycle of 28±8% for the diffraction efficiency of at least 75% in the case of 915±5 nm within ±4-degree incident angles.

16. The cladding grating of claim 13, wherein the grooves have a blazed cross section, and the grooves have a grating pitch of 660-700 nm, a grating depth of 200-400 nm and a asymmetricity of 60%-100%.

17. The cladding grating of claim 16, wherein the grooves have the grating pitch of 640±5 nm, the grating depth of 240±10 nm and the asymmetricity of 68±3% for the diffraction efficiency of at least 80% in the case of 915±5 nm within the incident angle of 0-4 degrees.

18. A fiber side-coupling apparatus comprising:
a semiconductor laser diode bar array, disposed at one side of an optical fiber, producing pump beams; and
a cladding grating, comprising:
a plurality of grating members, periodically formed on a cladding surface at the other side of the optical fiber, opposite the laser diode bar array, of an inner cladding, arrayed along a longitudinal direction of the optical fiber, wherein the grating members diffract the pump beams to produce diffracted beams propagating in the inner cladding of the optical fiber; and
a reflection layer, disposed on the grating members, configured to reflect the diffracted pump beams into the optical fiber.

19. The fiber side-coupling apparatus of claim 18, wherein the diffracted pump beams propagate in the inner cladding of the optical fiber due to total internal reflection.

20. The fiber side-coupling apparatus of claim 18, wherein each grating member has a binary cross section.

21. The fiber side-coupling apparatus of claim 18, wherein the grating members have a grating pitch of 660-700 nm, a grating depth of 120-170 nm and a duty cycle of 20%-45%.

22. The fiber side-coupling apparatus of claim 21, wherein the grating members have the grating pitch of 640±5 nm, the grating depth of 140±40 nm and the duty cycle of 28±8% for the diffraction efficiency of at least 75% in the case of 915±5 nm within ±4-degree incident angles.

23. The fiber side-coupling apparatus of claim 18, wherein each grating member has a blazed cross section.

24. The fiber side-coupling apparatus of claim 23, wherein the grating members have a grating pitch of 660-700 nm, a grating depth of 200-400 nm and an asymmetricity of 60%-100%.

25. The fiber side-coupling apparatus of claim 24, wherein the grating members have the grating pitch of 640±5 nm, the grating depth of 240±10 nm and the asymmetricity of 68±3% for the diffraction efficiency of at least 80% in the case of 915±5 nm within the incident angle of 0-4 degrees.

26. The fiber side-coupling apparatus of claim 18, further comprising a collimation device or a micro-lens array configured to collimate the pump beams incident to the grating members.
